(19) United States
(12) Patent Application Publication
(10) Pub. No.: US 2026/0203117 A1
(43) Pub. Date: Jul. 16, 2026

(54) SYSTEM FOR RESOURCE ALLOCATION IN A NETWORK ENVIRONMENT

(71) Applicant: MELLANOX TECHNOLOGIES, LTD., Yokneam (IL)

(72) Inventors: Ioannis (Giannis) PATRONAS, Piraeus (GR); Nikolaos TERZENIDIS, Kilkis (GR); Dimitrios SYRIVELIS, Volos (GR); Paraskevas BAKOPOULOS, Ilion (GR); Eitan ZAHAVI, Zichron Yaakov (IL); Zsolt-Alon WERTHEIMER, Kiryat Ata (IL); Louis Bennie CAPPS, JR., Georgetown, TX (US); Prethvi Ramesh KASHINKUNTI, Chicago, IL (US); Julie Irene Marcelle BERNAUER, Palo Alto, CA (US); Elad MENTOVICH, Tel Aviv (IL)

(73) Assignee: MELLANOX TECHNOLOGIES, LTD., Yokneam (IL)

(21) Appl. No.: 19/020,505

(22) Filed: Jan. 14, 2025

(30) Foreign Application Priority Data
Jan. 13, 2025 (GR) 20250100020

(51) Int. Cl. G06F 9/50

(52) U.S. Cl. CPC G06F 9/5027

(57) ABSTRACT

Systems, computer program products, and methods are described for resource allocation in a network environment. An example system includes resource allocation circuitry configured to receive a task allocation request, where the task allocation request comprises a task and a number of nodes required to execute the task. The example system determines the available electrical switches needed to allocate the task based on the number of nodes required and the number of nodes and/or available uplinks associated with each electrical switch. The example system allocates the task to a plurality of available nodes associated with the electrical switches and assigns portions of the task to minimize the links required to interconnect the electrical switches via the corresponding optical switches. The task is then executed using the allocated nodes.

### CROSS-REFERENCE TO RELATED APPLICATION

This application claims the benefit of Greek Patent Application No. 20250100020, Jan. 13, 2025, the contents of which is hereby incorporated by reference in its entirety.

### TECHNOLOGICAL FIELD

Example embodiments of the present disclosure relate to resource allocation in a network environment, specifically in a high-performance computing (HPC) clusters incorporating network switches.

### BACKGROUND

The introduction of optical switches (e.g., optical circuit switches) in a network environment presents new challenges for task allocation, as the topology and connectivity between various switch-groups depend on the configuration and state of the optical switch. Conventional task allocation methods primarily focus on compute node availability without adequately accounting for the availability of optical links. This can result in suboptimal performance due to increased inter-switch communication, leading to resource fragmentation and inefficiencies.

Applicant has identified a number of deficiencies and problems associated with optimal resource allocation in a network environment. Many of these identified problems have been solved by developing solutions that are included in embodiments of the present disclosure, many examples of which are described in detail herein.

### BRIEF SUMMARY

Systems, methods, and computer program products are therefore provided for resource allocation in a network environment to optimize task allocation by minimizing the number of optical links required to interconnect electrical switches, reducing communication overhead, and improving overall system performance.

In one aspect, a method for resource allocation in a network environment comprising electrical switches and optical switches is presented. The method comprising: receiving a task allocation request, wherein the task allocation request comprises a task and a number of nodes required to execute the task; determining available electrical switches required to allocate the task based on a number of nodes required to execute the task and a number of nodes associated with each available electrical switch, and/or a number of available uplinks in an uplink bundle associated with each electrical switch; allocating the task to a plurality of available nodes associated with the available electrical switches; assigning portions of the task to the plurality of available nodes such that links required to interconnect allocated electrical switches via corresponding optical switches is minimized; and executing the task using the plurality of available nodes.

In some embodiments, allocating the task further comprises: in an instance in which the task allocation spans multiple electrical switches, allocating portions of the task to available nodes associated with corresponding available electrical switches in a descending order of a number of available nodes associated with each corresponding available electrical switch until the task is successfully allocated.

In some embodiments, the method further comprises: in an instance in which the task allocation spans a singular electrical switch, allocating the portions of the task to available nodes associated with a first electrical switch, wherein the first electrical switch is selected from the available electrical switches having a number of available nodes that are greater than the number of nodes required to execute the task, and wherein the first electrical switch has a minimum number of available nodes among the available electrical switches.

In some embodiments, the method further comprises: in an instance in which the task allocation does not span the singular electrical switch, determining whether the task allocation spans multiple electrical switches.

In some embodiments, the method further comprises: in an instance in which a total number of available nodes is less than the number of nodes required to execute the task, transmitting an alert to a user indicating that the task allocation request was unsuccessful.

In some embodiments, the method further comprises: queuing the task allocation request until additional nodes are available.

In some embodiments, the task is a Large Language Model (LLM) task, wherein the LLM task employs multi-dimensional parallelism comprising at least one of data parallelism (DP), tensor parallelism (TP), pipeline parallelism (PP), or expert parallelism (EP).

In some embodiments, the plurality available nodes across the available electrical switches are operatively interconnected in a reduction communication pattern for the DP dimension, and wherein the portions of the task are assigned to the plurality of available nodes such that inter-switch communication is minimized.

In some embodiments, the plurality of available nodes across the available electrical switches are operatively interconnected in a point-to-point communication pattern for the PP dimension, and wherein the portions of the task are assigned to the plurality of available nodes such that inter-switch communication is minimized.

In some embodiments, the plurality of available nodes across the available electrical switches are operatively interconnected in an all-to-all communication pattern for the EP dimension, and wherein the portions of the task are assigned to the plurality of available nodes such that inter-switch communication is minimized.

In some embodiments, the task is a Deep Learning Recommendation Machine (DLRM) task, wherein the plurality of available nodes are operatively interconnected in an all-to-all, a reduction operation, or a scatter-gather communication pattern.

In some embodiments, the method further comprises: upon successful allocation of the task, determining the links required to interconnect the allocated electrical switches.

In another aspect, a system for resource allocation in a network environment is presented. The system comprising: a plurality of electrical switches; a plurality of optical switches operatively coupled to the plurality of electrical switches; resource allocation circuitry operatively coupled to the plurality of electrical switches and the plurality of optical switches, and configured to: receive a task allocation request, wherein the task allocation request comprises a task and a number of nodes required to execute the task; determine available electrical switches required to allocate the task based on a number of nodes required to execute the task and a number of nodes associated with each available electrical switch, and/or a number of available uplinks in an uplink bundle associated with each electrical switch; allocate the task to a plurality of available nodes associated with the available electrical switches; assign portions of the task to the plurality of available nodes such that links required to interconnect allocated electrical switches via corresponding optical switches is minimized; and execute the task using the plurality of available nodes.

In yet another aspect, a computer program product for resource allocation in a network environment is presented. The computer program product comprising a non-transitory computer-readable medium comprising code, when executed by a processor, causes the processor to: receive a task allocation request, wherein the task allocation request comprises a task and a number of nodes required to execute the task; determine available electrical switches required to allocate the task based on a number of nodes required to execute the task and a number of nodes associated with each available electrical switch, and/or a number of available uplinks in an uplink bundle associated with each electrical switch; allocate the task to a plurality of available nodes associated with the available electrical switches; assign portions of the task to the plurality of available nodes such that links required to interconnect allocated electrical switches via corresponding optical switches is minimized; and execute the task using the plurality of available nodes.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example network architecture, in accordance with an embodiment of the disclosure;

FIG. 2 illustrates a schematic block diagram of example circuitry, some or all of which may be included in the subsystem, in accordance with an embodiment of the disclosure;

FIG. 3 illustrates an example method for resource allocation in a network environment, in accordance with an embodiment of the disclosure;

FIGS. 4A and 4B illustrate an example segment of the network environment illustrating optimal resource allocation, in accordance with an embodiment of the disclosure.

### DETAILED DESCRIPTION

### Overview

High-performance computing (HPC) clusters, especially those incorporating optical switches, are increasingly used for large-scale computational tasks requiring efficient task placement and resource management for optimal performance. The integration of optical switches improves data transfer rates and reduce latency, making these clusters suitable for demanding applications such as Deep Learning Recommendation Models (DLRM) and Large Language Models (LLM).

In HPC clusters with optical switches, task placement must consider both compute node availability and link availability on the optical switches between electrical switches. Conventional algorithms focusing solely on node availability can lead to suboptimal performance due to increased inter-switch communication, necessitating more optical circuits. This results in cluster fragmentation and stranded resources, undermining the benefits of optical switch integration. The challenge lies in minimizing the required number of optical links while efficiently allocating nodes to reduce communication overhead between electrical switches.

Embodiments of the invention address these challenges by implementing a two-step process aimed at minimizing the links required to interconnect the available electrical switches via corresponding optical switches for task allocation. The first step targets tasks that can span a single electrical switch, reducing cluster fragmentation and stranded resources. This involves creating a list of electrical switches sorted by the number of available compute nodes and sequentially allocating nodes from the fullest switch downwards until the required number of nodes is met. The second step addresses multi-electrical switch tasks, aiming to minimize the number of electrical switches that the job spans and the number of optical links required to connect them. This is achieved by creating a list of electrical switches sorted by the number of available compute nodes and sequentially allocating nodes from the emptiest switch downwards until the required number of nodes is met. Portions of the task (e.g., ranks, processes, etc.) are then allocated to available nodes on the electrical switches such that communication between electrical switches via corresponding optical switches is minimized. The method can be applied to Deep Learning Recommendation Machine (DLRM) and Large Language Model (LLM) tasks, as well as other future workloads. Performance can be further improved by optimizing the sorting metric, such as incorporating the number of free uplinks, potentially moving away from using the number of free servers as the primary criterion.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

Furthermore, as would be evident to one of ordinary skill in the art in light of the present disclosure, the terms “substantially” and “approximately” indicate that the referenced element or associated description is accurate to within applicable engineering tolerances.

### Example Datacenter Architecture

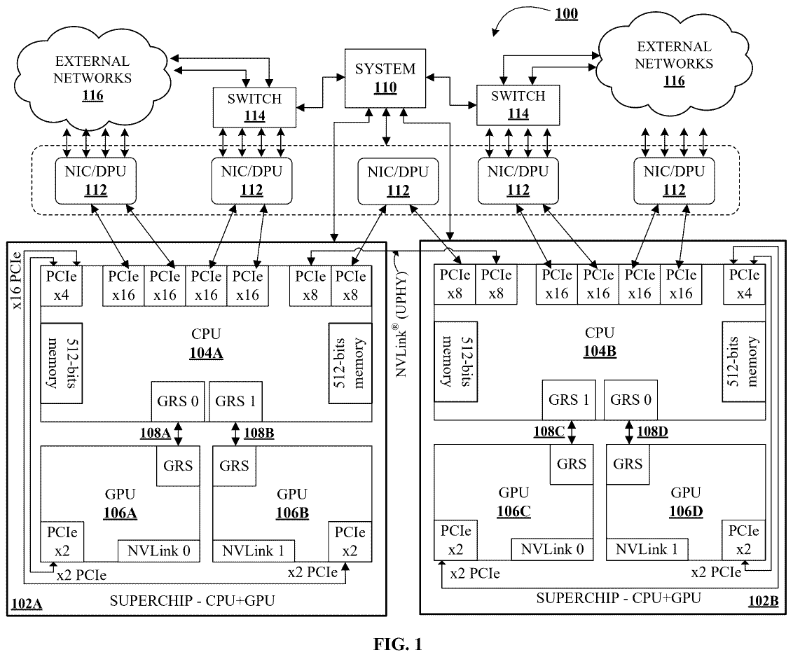

FIG. 1 illustrates a schematic diagram of an example datacenter network architecture 100, in accordance with an embodiment of the disclosure. The datacenter network architecture 100 may include high-performance computing (HPC) clusters 102A, 102B, network interface controller/data processing units (NIC/DPUs) 108, switches 114, external networks 116, and system 110. The HPC clusters 102A, 102B may house computing resources. The NIC/DPUs 112 may act as intermediate processing and management units that facilitate data transmission between HPC clusters 102A, 102B and datacenter switches 114. The datacenter switches 114 may manage and route data between the HPC clusters 102A, 102B and the external networks 116. The external networks 116 may connect the datacenter network architecture 100 to external devices, services, or other datacenters, enabling communication beyond the datacenter. The system 110 may serve as a centralized management and control system within datacenter network architecture 100, overseeing resource allocation, link management, and network optimization, according to various embodiments described herein.

HPC clusters (e.g., HPC clusters 102A, 102B) may house various computing resources designed to support computationally demanding tasks. These HPC clusters may include central processing units (CPUs), such as NVIDIA Grace™ CPUs, and graphics processing units (GPUs), such as NVIDIA® H100 Tensor Core GPUs, memory modules, and interconnects to facilitate data exchange and processing. In example embodiments, each HPC cluster may be configured to handle specific types of workloads, such as general-purpose computing, data processing, specialized tasks like artificial intelligence (AI) and machine learning (ML) applications, and/or the like. For example, NVIDIA^{®}Tensor Core GPUs may be used to accelerate AI and ML workloads by performing parallel processing of large datasets. The configuration of the HPC clusters may be scalable, allowing for additional compute nodes, such as those with GPUs and CPUs, to be added or removed as needed based on computing requirements.

In specific embodiments, the CPU and/or the GPUs, or portions or components thereof, may be embodied as or include a chip or chipset. In other words, the CPU and/or the GPUs may include physical packages (e.g., chips) including materials, components, and/or wires on a structural assembly (e.g., a baseboard). The structural assembly may provide physical strength, conservation of size, and/or limitation of electrical interaction for component circuitry included thereon. The CPU and/or the GPUs, may therefore, in some cases, be configured to implement an embodiment of the disclosure on a single chip or as a single “system on a chip (SoC).” As such, in some cases, a chip or chipset may constitute means for performing one or more operations for providing the functionalities described herein. In this configuration, the CPU may be coupled to a GPU via die-to-die (D2D) interconnects, chip-to-chip (C2C) interconnects, such as a Ground-Referenced Signaling (GRS) interconnect, and/or the like, allowing for low-latency communication and high bandwidth between the CPU and GPU. Additionally, the CPU can connect to multiple GPUs using both D2D/C2C interconnects and high-speed interconnects, such as PCIe interconnects, such as PCIe Gen 5 ×16 lanes. Within each HPC cluster, the GPUs may also be operatively coupled to one another to facilitate direct GPU-to-GPU communication using high-speed interconnect technologies such as NVLink® or other interconnects specifically designed for direct GPU communication. NVLink® may provide a high-bandwidth, low-latency communication channel between GPUs, supporting data synchronization and sharing for tasks that require significant inter-GPU communication, such as matrix computations, simulations, or AI model training.

In the embodiment shown in FIG. 1, CPU 104A is operatively coupled to GPUs 106A and 106B via GRS-compatible interconnects, 108A and 108B, and CPU 104B is operatively coupled to GPUs 104C and 106D via GRS-compatible interconnects, 108C and 108D. Each CPU may include GRS-compatible ports, such as GRS 0 and GRS 1, which are configured to interface with corresponding GRS ports on the GPUs. For example, CPU 104A may utilize its GRS 0 port to connect to GPU 106A and its GRS 1 port to connect to GPU 106B, while CPU 104B may use its GRS 0 and GRS 1 ports to connect to GPUs 104C and 106D, respectively. The GRS-compatible interconnects may provide pathways for data exchange, workload distribution, and processing synchronization between the CPUs and GPUs, supporting high-bandwidth, low-latency communication. Alternatively or additionally, the CPUs 104A and 104B may be operatively coupled to GPUs 106A, 106B, 106C, and 106D via PCIe interconnects. These PCIe interconnects may utilize multi-lane configurations, such as PCIe Gen 4 or Gen 5 ×16 lanes, to provide high-bandwidth, scalable data transfer channels between the CPUs and GPUs. In this configuration, the PCIe interconnects may support dynamic link width adjustments, allowing the bandwidth to scale based on workload intensity, thereby optimizing resource allocation within the system.

GPUs 106A and 106B within HPC cluster 102A and GPUs 104C and 106D within HPC cluster 102B may be interconnected via NVLink® interconnects via NVLink® compatible ports, NVLink 0 and NVLink 1 respectively, allowing coordinated parallel processing across GPUs for computationally demanding workloads. HPC clusters 102A and 102B may be interconnected through high-bandwidth interconnect, such as an NVLink® or Unified Physical Layer (UPHY) interconnect, allowing for data transfer and synchronization between the server systems. The high-bandwidth interconnect may support parallel processing and may improve the overall computational throughput of the HPC cluster, making it suitable for applications like artificial intelligence (AI), machine learning (ML), and data-intensive simulations. Each CPU (e.g., 104A) within a HPC cluster (e.g., 102A) may be equipped with memory modules, such as a 512-bit memory module, to provide data access for both CPUs and GPUs. The memory modules may be directly connected to the respective CPUs, reducing latency and supporting high-speed operations.

As shown in FIG. 1, the HPC clusters 102A and 102B may be operatively coupled to NIC/DPUs 112, enabling efficient offloading of data processing and security tasks, further reducing the computational burden on the server CPUs and improving overall data flow within the rack. Each NIC/DPU 112 may integrate NIC and DPU functionalities to enhance the efficiency of data center operations. The NIC/DPU 112 may be configured to offload various network, storage, and security tasks from the HPC clusters (e.g., HPC cluster 102A, 102B), in particular, CPUs in the HPC clusters, allowing the CPUs to focus on compute-intensive workloads. The NIC/DPU 112 may facilitate high-speed data transmission, optimize data flow, and enable advanced network services with minimal impact on server performance. The NIC component within the NIC/DPU 112 may handle standard network functions, such as packet transmission and reception, supporting high-speed Ethernet or InfiniBand® protocols. By facilitating fast data transfers between the HPC clusters 102A and 102B and external networks 116, the NIC enables efficient communication across the datacenter environment. The NIC may also support offloading network protocol processing, reducing the overhead on HPC clusters 102A and 102B, in particular, CPUs in the HPC clusters 102A and 102B, and improving overall data throughput. The DPU component of the NIC/DPU 112 may extend these capabilities by offloading more advanced processing tasks, such as data encryption and decryption, packet inspection and filtering, virtualization support, and/or the like. In example embodiments, DPU may be NVIDIA BlueField®-2 DPUs, which provide a high-performance platform for data center acceleration. The BlueField-2 architecture may include up to 8 Arm cores, enabling the NIC/DPU 112 to execute network, storage, and security tasks independently of the HPC clusters, in particular, CPUs in the HPC clusters. By performing these tasks closer to the data source, the NIC/DPU 112 may reduce data movement across the network, lower latency, and enhance overall system efficiency.

The NIC/DPU 112 may also include a dedicated memory subsystem, such as dynamic random-access memory (DRAM), to support local processing and ensure high-speed data access. Additionally, the NIC/DPU 112 may be configured to manage NVMe over Fabrics (NVMe-oF) storage protocols, allowing for efficient remote storage access and fast data retrieval. The combined NIC and DPU functionalities within the NIC/DPU 112 may support various advanced networking features, including traffic shaping and load balancing, remote direct memory access (RDMA), virtual machine and container isolation, and/or the like.

Switches 114 may manage the data flow between the HPC clusters 102A, 102B and the external networks 116. The switches 114 may be responsible for routing and distributing data between servers within the datacenter and facilitating communication with external networks. Switches 114 may be configured to support various high-speed network protocols, such as Ethernet or InfiniBand® protocols, depending on the performance and bandwidth requirements of the datacenter. The switches 114 may include optical switches, which use light signals for data transmission, offering high bandwidth and low latency for long-distance communication. Alternatively, the switches 114 may include electrical switches, which rely on electronic signals and may be used for shorter distances or when lower latency is a priority. In some configurations, hybrid switches may be used, combining both optical and electrical components to balance performance and flexibility. The switches 114 may be advanced networking switches, such as Nvidia Quantum-2 switches, configured to provide high throughput capabilities. The switches 114 may operate at different layers of the network stack, including Layer 2 (data link layer) and Layer 3 (network layer), to perform switching and routing functions. Multiple switches 114 may be interconnected to provide redundancy and load balancing for reliable data transfer even if one switch fails. The switches 114 may support scalable configurations, allowing the network architecture to expand as additional HPC clusters 102A, 102B or external networks 116 are introduced.

In certain embodiments, the number and arrangement of switches 114 within the datacenter network architecture 100 may be based on the overall network topology deployed in the datacenter environment. The choice of network topology may influence the scalability, performance, fault tolerance, and bandwidth distribution of the network, thus affecting how many switches are required and how they are interconnected. Examples of network topology may include fat-tree topology, SlimFly topology, dragonfly topology, HyperX topology, torus topology, Clos (folded-Clos) topology, mesh topology and/or the like. For instance, in a fat-tree topology, the network is structured as a multi-tiered hierarchy with equal-cost paths between any two endpoints. The fat-tree topology may be built using three layers of switches: leaf switches at the bottom layer, directly connected to the HPC clusters 102A, 102B, spine switches in the middle layer, which interconnect the leaf switches, and core switches at the top, which interconnect multiple sets of spine switches. In a SlimFly topology, the switches 114 may be arranged to minimize the average path length between servers, reducing communication latency. The total number of switches 114 may be fewer than in fat-tree topology, but their arrangement may be more complex to optimize the number of direct and indirect connections between nodes. Dragonfly topology may organize switches into groups (or “pods”), with high-bandwidth connections within each group and lower-bandwidth connections between groups. The switches 114 may be arranged into several pods, with each pod containing a set of leaf switches connected to HPC clusters 102A, 102B and local spine switches. In addition, there may be fewer inter-pod connections than intra-pod connections. In hyperX topology, switches may be arranged in a multi-dimensional grid, with each switch connected to multiple neighboring switches in different dimensions. The total number of switches may scale with the number of dimensions and network size. In a torus topology, the switches 114 may be connected in a loop or ring structure. Torus topology may offer reduced wiring complexity and built-in redundancy, as each switch is connected to multiple adjacent switches. In larger datacenters, a higher-dimensional torus (e.g., 3D or 4D torus) may be implemented, where switches are arranged in a multi-layered grid. In a Clos topology, also known as a folded-Clos or CLOS architecture, the switches 114 may be arranged in multiple layers of switching stages, with each stage containing multiple switches. In this configuration, each server system 102 may connect to a set of leaf switches, which in turn connect to multiple spine switches. Additional spine and leaf switches may be added as the network grows, with the number of switches 114 increasing in proportion to the number of server systems and external networks connected.

The external networks 116 represent a range of connectivity options that facilitate communication between the datacenter and various external systems, such as other datacenters, cloud service providers, and/or the like. These external networks 116 may include local area networks (LANs), which connect devices within a limited geographical area, as well as WANs that span larger distances and connect multiple LANs. Additionally, external networks 116 may include cloud networks, which provide scalable resources and services hosted remotely, and private networks, which offer secure communication channels for sensitive data transfer. Other types of external networks may include virtual private networks (VPNs) that enable secure access over the internet and Content Delivery Networks (CDNs) that optimize the delivery of content to end-users. Each of these external networks may utilize various communication protocols, such as Ethernet, InfiniBand®, or MPLS (Multiprotocol Label Switching) protocols, to ensure reliable and efficient data transfer.

System 110 may manage and coordinate network resources within the datacenter network architecture 100, including link allocation and other resource distribution functionalities described herein. System 110 may be operatively coupled to various components, such as the HPC clusters 102A, 102B, NIC/DPU 112, and switches 114, facilitating efficient communication and resource management across the network infrastructure. In specific embodiments, the system 110 may interact with NIC/DPUs 112 to offload specific network management and data processing tasks from the HPC clusters 102A, 102B. The NIC/DPUs 112 may handle low-level data exchanges and route packets between HPC clusters 102A, 102B and network switches 106, enabling system 110 to focus on higher-level management tasks, such as link allocation across the data center environment. System 110 may communicate with NIC/DPUs 112 to monitor network conditions, adjust link allocations in response to changing demands, and ensure optimized data flows across the infrastructure. System 110 may also be in direct communication with network switches 106, which route data between HPC clusters 102A, 102B and external networks 116. Through this interaction, system 110 may determine the optimal allocation of network links for data transmission across switches 106, minimizing congestion and ensuring efficient resource utilization. In some embodiments, system 110 may control the allocation of both electrical and optical links, as well as the number of links activated or deactivated between switches 106 based on network traffic patterns. System 110 may adjust link allocations dynamically, managing inter-switch communication in response to varying data loads or operational demand.

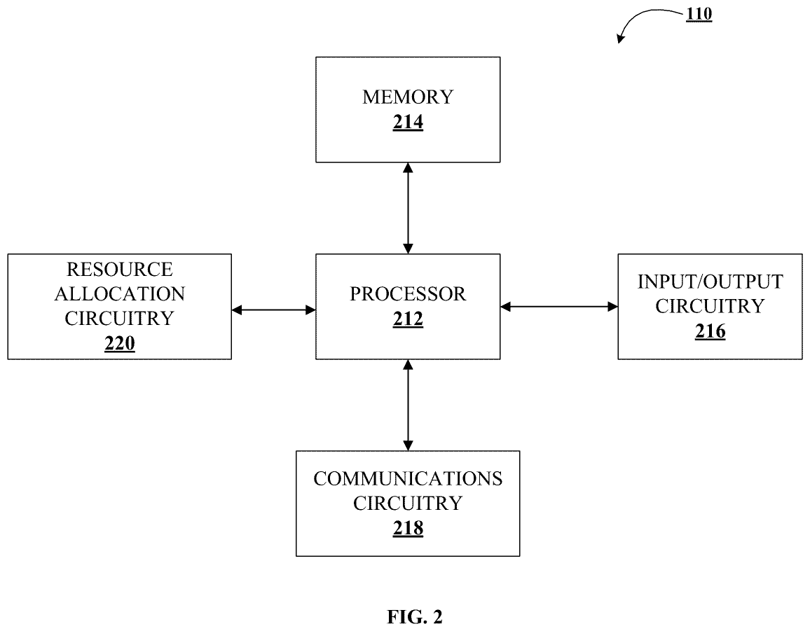

Within HPC clusters 102A, 102B, system 110 may oversee the distribution of computational tasks and manage interconnects between CPUs, GPUs, and other processing resources. For instance, system 110 may allocate available link bandwidth between CPUs and GPUs based on workload requirements, facilitating high-throughput, low-latency data exchanges as needed for AI, ML, and other computationally intensive applications. System 110 may use link allocation circuitry 220 (see FIG. 2) to implement link allocation policies across the datacenter environment, adjusting link usage according to the computational load and inter-device communication needs, as described herein.

Overall, system 110 may serve as the central control point for link allocation and network resource management within the datacenter network architecture 100, coordinating with NIC/DPUs 112, HPC clusters 102A, 102B, and switches 106 to ensure efficient resource utilization and optimized data flows across the network.

It should be noted that the description provided herein is merely one embodiment of the datacenter network architecture 100 and the associated components, including the switches 114 and the NIC/DPU 112. Various modifications, alterations, and adaptations may be made without departing from the scope of the disclosure. The specific configurations, components, and functionalities described are illustrative and may be replaced or modified in other embodiments depending on the particular requirements of the datacenter environment. For example, different network topologies, alternative processing units, or variations in server configurations may be used to achieve similar objectives. As such, the scope of the invention should not be limited by the described embodiment.

### Example System Circuitry

FIG. 2 illustrates a schematic block diagram of example circuitry, some or all of which may be included in the system 110. As shown in FIG. 2, the system 110 may include a processor 212, a memory 214, input/output circuitry 216, communications circuitry 218, and resource allocation circuitry. It should be understood that FIG. 2 is merely an illustrative embodiment and the system 110 may include more components, fewer components, or different components than those depicted. The arrangement of the components may also vary. Depending on specific implementation requirements, the system 110 may incorporate additional components or omit certain components. Variations in the configuration and composition of the system 110 are within the scope of the disclosure.

Although the term “circuitry” as used herein with respect to components 212-220 is described in some cases using functional language, it should be understood that the particular implementations necessarily include the use of particular hardware configured to perform the functions associated with the respective circuitry as described herein. It should also be understood that certain of these components 212-220 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the system 110 may be housed together, while other components are housed separately (e.g., a controller in communication with the system 110). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the system 110 may provide or supplement the functionality of particular circuitry. For example, the processor 212 may provide processing functionality, the memory 214 may provide storage functionality, the communications circuitry 218 may provide network interface functionality, and the like.

In some embodiments, the processor 212 (and/or co-processor or any other processing circuitry assisting or otherwise associated with the processor) may be in communication with the memory 214 via a bus for passing information among components of, for example, the system 110. The memory 214 may be non-transitory and may include, for example, one or more volatile and/or non-volatile memories, or some combination thereof. In other words, for example, the memory 214 may be an electronic storage device (e.g., a non-transitory computer readable storage medium). The memory 214 may be configured to store information, data, content, applications, instructions, or the like, for enabling an apparatus, e.g., the system 110, to carry out various functions in accordance with example embodiments of the present disclosure.

Although illustrated in FIG. 2 as a single memory, the memory 214 may comprise a plurality of memory components. The plurality of memory components may be embodied on a single computing device or distributed across a plurality of computing devices. In various embodiments, the memory 214 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 214 may be configured to store information, data, applications, instructions, or the like for enabling the system 110 to carry out various functions in accordance with example embodiments discussed herein. For example, in at least some embodiments, the memory 214 may be configured to buffer data for processing by the processor 212. Additionally, or alternatively, in at least some embodiments, the memory 214 may be configured to store program instructions for execution by the processor 212. The memory 214 may store information in the form of static and/or dynamic information. This stored information may be stored and/or used by the system 110 during the course of performing its functionalities.

The processor 212 may be embodied in a number of different ways and may, for example, include one or more processing devices configured to perform independently. Additionally, or alternatively, the processor 212 may include one or more processors configured in tandem via a bus to enable independent execution of instructions, pipelining, and/or multithreading. The processor 212 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 212 may include a plurality of processors. The plurality of processors may be embodied on a single computing device or may be distributed across a plurality of such devices collectively configured to function as the system 110. The plurality of processors may be in operative communication with each other and may be collectively configured to perform one or more functionalities of the system 110 as described herein.

In an example embodiment, the processor 212 may be configured to execute instructions stored in the memory 214 or otherwise accessible to the processor 212. Alternatively, or additionally, the processor 212 may be configured to execute hard-coded functionality. As such, whether configured by hardware or software methods, or by a combination thereof, the processor 212 may represent an entity (e.g., physically embodied in circuitry) capable of performing operations according to an embodiment of the present disclosure while configured accordingly. Alternatively, as another example, when the processor 212 is embodied as an executor of software instructions, the instructions may specifically configure the processor 212 to perform one or more algorithms and/or operations described herein when the instructions are executed. For example, these instructions, when executed by the processor 212, may cause the system 110 to perform one or more of the functionalities thereof as described herein.

In some embodiments, the system 110 further includes input/output circuitry 216 that may, in turn, be in communication with the processor 212 to provide an audible, visual, mechanical, or other output and/or, in some embodiments, to receive an indication of an input from a user or another source. In that sense, the input/output circuitry 216 may include means for performing analog-to-digital and/or digital-to-analog data conversions. The input/output circuitry 216 may include support, for example, for a display, touchscreen, keyboard, mouse, image capturing device (e.g., a camera), microphone, and/or other input/output mechanisms. The input/output circuitry 216 may include a user interface and may include a web user interface, a mobile application, a kiosk, or the like. The input/output circuitry 216 may interface with one or more units, devices, sensors, actuators, communication modules, storage devices, external processing units, peripheral devices, and/or the like. These outputs may then be transmitted to one or more destinations, such as display units, storage systems, control systems, processors (e.g., processor 212), network interfaces, peripheral devices, external systems, and/or the like, for further action.

The processor 212 and/or user interface circuitry comprising the processor 212 may be configured to control one or more functions of a display or one or more user interface elements through computer-program instructions (e.g., software and/or firmware) stored on a memory accessible to the processor 212 (e.g., the memory 214, and/or the like). In some embodiments, aspects of input/output circuitry 216 may be reduced as compared to embodiments where the system 110 may be implemented as an end-user machine or other type of device designed for complex user interactions. In some embodiments (like other components discussed herein), the input/output circuitry 216 may be eliminated from the system 110. The input/output circuitry 216 may be in communication with memory 214, communications circuitry 218, and/or any other component(s), such as via a bus. Although more than one input/output circuitry and/or other component can be included in the system 110, only one is shown in FIG. 2 to avoid overcomplicating the disclosure (e.g., as with the other components discussed herein).

The communications circuitry 218, in some embodiments, includes any means, such as a device or circuitry embodied in either hardware, software, firmware or a combination of hardware, software, and/or firmware, that is configured to receive and/or transmit data from/to a network and/or any other device, or circuitry associated therewith. In this regard, the communications circuitry 218 may include, for example, a network interface for enabling communications with a wired or wireless communication network. For example, in some embodiments, communications circuitry 218 may be configured to receive and/or transmit any data that may be stored by the memory 214 using any protocol that may be used for communications between computing devices. For example, the communications circuitry 218 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 218 may include circuitry for interacting with the antenna(s) to cause transmission of signals via the antenna(e) or to handle receipt of signals received via the antenna(e). These signals may be transmitted by the system 110 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 218 may additionally or alternatively be in communication with the memory 214, the input/output circuitry 216, and/or any other component of the system 110, such as via a bus.

Referring again to FIG. 2, the resource allocation circuitry 220, in response to receiving task allocation requests, may be configured to determine the availability of electrical switches and the corresponding compute nodes based on the number of nodes required and/or the number of available uplinks associated with each electrical switch. The resource allocation circuitry 220 may then allocate the task to the available nodes associated with the selected electrical switches, ensuring that portions of the task are assigned in a manner that minimizes the number of optical links required to interconnect the allocated switches. The resource allocation circuitry 220 may also be configured to adjust task allocations in scenarios where tasks span multiple electrical switches, by selecting switches in a descending order of available nodes or based on other criteria such as uplink availability. Once allocated, the resource allocation circuitry 220 may execute the task using the assigned nodes and monitor the inter-switch communication to ensure optimal performance.

In some embodiments, the system 110 may include hardware, software, firmware, and/or a combination of such components, configured to support various aspects of combinatorial optimization as described herein. It should be appreciated that in some embodiments, the resource allocation circuitry 220 may perform one or more of such example actions in combination with another circuitry of the system 110, such as the memory 214, processor 212, input/output circuitry 216, and communications circuitry 218. For example, in some embodiments, the resource allocation circuitry 220 may utilize processing circuitry, such as the processor 212 and/or the like, to form a self-contained subsystem to perform one or more of its corresponding operations. In a further example, and in some embodiments, some or all of the functionality of the resource allocation circuitry 220 may be performed by the processor 212. In this regard, some or all of the example processes and algorithms discussed herein can be performed by at least one processor 212, and the resource allocation circuitry 220. It should also be appreciated that, in some embodiments, the resource allocation circuitry 220 may include a separate processor, specially configured FPGA, or ASIC to perform its corresponding functions.

Additionally, or alternatively, in some embodiments, the resource allocation circuitry 220 may use the memory 214 to store collected information. For example, in some implementations, the resource allocation circuitry 220 may include hardware, software, firmware, and/or a combination thereof, that interacts with the memory 214 to send, retrieve, update, and/or store data.

Accordingly, non-transitory computer readable storage media, which may, for example, be the memory 214, can be configured to store firmware, one or more application programs, and/or other software, which include instructions and/or other computer-readable program code portions that can be executed to direct operation of the system 110 to implement various operations, including the examples described herein. As such, a series of computer-readable program code portions may be embodied in one or more computer-program products and can be used, with a device, system 110, database, and/or other programmable apparatus, to produce the machine-implemented processes discussed herein. It is also noted that all or some of the information discussed herein can be based on data that is received, generated and/or maintained by one or more components of the system 110. In some embodiments, one or more external systems (such as a remote cloud computing and/or data storage system) may also be leveraged to provide at least some of the functionality discussed herein.

### Example Method for Resource Allocation in a Network Environment

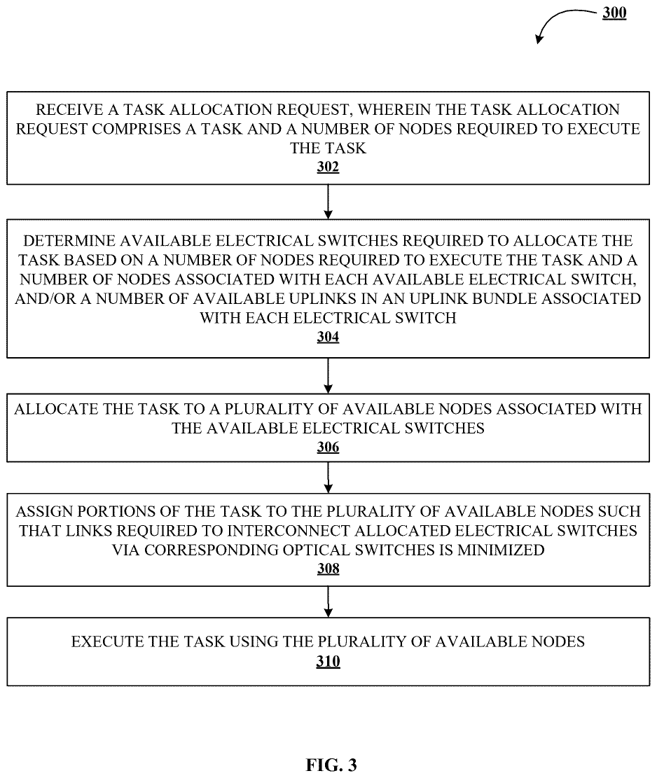

FIG. 3 illustrates an example method 300 for resource allocation in a network environment, in accordance with an embodiment of the disclosure. The method 300 may be executed by the system 110 to allocate computational tasks across available nodes in a network environment.

As shown in block 302, the task allocation request is received. The task allocation request may include a task and a number of nodes required to execute the task. The task may represent a computational workload, such as a machine learning model, simulation, or other data-intensive process. In one example embodiments, the task may be a Deep Learning Recommendation Models (DLRM) task. DLRMs are used in personalized recommendation systems to predict user preferences by analyzing large-scale datasets containing both categorical and numerical features. DLRM models typically involve embedding operations, where categorical features are transformed into dense vectors, and intricate feature interaction layers that combine both categorical and numerical data. The primary computational challenge in DLRMs is efficiently managing large embedding tables and performing interaction operations between features. DLRM models benefit from distributed environments that can allocate tasks across multiple compute nodes to manage the massive embedding tables and parallelize the dense computations.

In another example embodiment, the task may be a Large Language Models (LLM). LLMs are used for natural language processing tasks, such as text generation, translation, question-answering, and summarization. LLM models are characterized by their large size and complexity, often involving billions or even trillions of parameters. Due to their size, LLMs are typically executed in distributed environments where the computational load is divided across multiple nodes. LLMs may employ multi-dimensional parallelism to efficiently handle their extensive computational and memory requirements. For instance, LLMs may employ data parallelism (DP), tensor parallelism (TP), and pipeline parallelism (PP) to distribute the computational load. DP may involve splitting the input data across multiple nodes, each processing different subsets of the data in parallel. TP may be used to distribute the operations of large matrix and tensor computations across multiple nodes, allowing for the efficient execution of large-scale neural networks. PP may divide the model into sequential stages, where each stage processes a portion of the input and then passes it to the next stage. This allows for concurrent processing of different parts of the model across nodes. In some cases, LLMs that use Mixture-of-Experts (MoE) layers may also employ expert parallelism (EP). Unlike other forms of model parallelism, EP is only applied to the expert layers within the MoE architecture. In this approach, the expert layers—composed of distinct experts—are distributed across multiple nodes or GPUs, while the rest of the model remains mapped using other parallelism strategies, such as TP, DP, or PP. This allows for more efficient allocation of compute resources by activating only a subset of the experts for any given input, thereby reducing the overall computational load while maintaining high model capacity.

The number of nodes specified in the request may correspond to the amount of computational resources necessary to complete the task, based on factors such as data size, complexity of computations, and/or the like. For example, tasks involving larger datasets may require more nodes to distribute the data across multiple compute resources, enabling parallel processing. Similarly, tasks with high computational complexity, such as training large-scale neural networks or performing complex simulations, may demand additional nodes to handle the increased processing workload, memory requirements, or specialized hardware capabilities like GPUs or tensor processing units (TPUs). In the case of DL models, the number of nodes may also depend on the specific parallelism strategies employed. For example, for LLM tasks employing DP, more nodes may be necessary to divide the input data into smaller batches that can be processed simultaneously across multiple nodes; for LLM tasks employing TP or PP, the number of nodes may be determined by the size and structure of the model itself, where different portions of the model or computations are distributed across multiple nodes to optimize processing efficiency and memory usage.

In distributed computing environments, tasks executed across multiple nodes may require efficient communication patterns to manage data exchange and coordination between nodes. Communication patterns define the ways in which data is transmitted and shared across a network of nodes during task execution.

In examples where the task is a DLRM task, the available nodes may be operatively interconnected in an all-to-all, a reduction operation, or a scatter-gather communication pattern. In an all-to-all communication pattern, each node may communicate directly with every other node, which is particularly useful for tasks requiring extensive data sharing and synchronization. The all-to-all communication pattern may enable each node to access data processed by other nodes, such that all parts of the system work with consistent and complete information. A reduction operation pattern may be used for aggregating partial results from multiple nodes. Nodes perform individual computations on distributed data, and then the results may be progressively combined into a single, aggregated result. In the scatter-gather communication pattern, data may be initially distributed from a central node to multiple worker nodes, where each node processes a portion of the data independently. After processing, the results may be collected, or “gathered,” back to the central node for final aggregation or further computation.

In an example embodiment where the task is a Large Language Model (LLM) task, the dimensionality of the parallelism employed—DP, TP, EP, or PP—may inform the type of communication pattern used to interconnect the available nodes across the electrical switches. Each dimension of parallelism may impose different data-sharing and computational requirements, necessitating different communication strategies to optimize performance and reduce inter-switch communication overhead. For DP, where the same model is trained on different subsets of data across multiple nodes, a reduction communication pattern may be employed. For PP, where the model is split into sequential stages, a point-to-point communication pattern may be used. In case of EP, where only certain expert layers of the model are distributed across nodes in a MoE framework, an all-to-all communication pattern may be employed. By selecting appropriate communication patterns based on the parallelism dimensions of the LLM task, the system may ensure that the computational and data transfer requirements are met while minimizing inter-switch communication. Such an approach allows for efficient task execution, even in highly distributed environments where nodes span multiple electrical and optical switches.

Additionally, the number of nodes requested may account for the communication overhead associated with the task, such as the need for inter-node data exchanges in multi-dimensional parallelism strategies. In such cases, the task allocation request may factor in the need for sufficient network bandwidth and low-latency communication between nodes to ensure that the distributed computations are performed efficiently without creating bottlenecks. Thus, the number of nodes specified in the request reflects not only the raw computational demand of the task but also the need for optimized resource allocation and network communication.

As shown in block 304, the number of available electrical switches required to allocate the task is determined based on a number of nodes required to execute the task and a number of nodes associated with each available electrical switch, and/or a number of available uplinks in an uplink bundle associated with each electrical switch. The system may evaluate the available electrical switches in the network, considering both the compute capacity of each electrical switch (i.e., the number of nodes connected to each electrical switch) and the network capacity (i.e., the number of uplinks available for communication between electrical switches). For tasks requiring a high number of nodes, the system may need to allocate resources across multiple electrical switches. In this case, the system may consider the availability of uplinks that facilitate communication between these switches, particularly in configurations involving optical switches. By factoring in the number of available uplinks, the system aims to minimize communication bottlenecks and inter-switch latency. In an example embodiment, the number of uplinks available for communication between electrical switches may be specific to an uplink bundle. An uplink bundle may refer to a collection of links connecting an electrical switch to the same optical switch. Each uplink bundle may represent a group of connections that enables data transmission between the electrical switch and an optical switch, facilitating communication across the network. In network environments where both electrical and optical switches are used, uplink bundles may define the capacity and performance of the system. The size of the uplink bundle may determine how much traffic can be routed from an electrical switch through a particular optical switch.

As shown in block 306, the task is allocated to a plurality of available nodes associated with the available electrical switches. In this regard, system may first evaluate whether the task allocation can be satisfied by nodes from a single electrical switch or if it will span multiple switches.

In an instance in which the task allocation spans multiple electrical switches, the system may allocate portions of the task to available nodes associated with the corresponding electrical switches in a descending order of the number of available nodes associated with each switch. This approach may ensure that the system first uses the switches with the largest number of available nodes, reducing fragmentation and minimizing the number of electrical switches required to complete the task allocation. The allocation continues until the total number of required nodes is met, optimizing both node usage and inter-switch communication by concentrating the allocation on fewer switches when possible.

In an instance in which the task allocation spans a singular electrical switch, the system may allocate the portions of the task to available nodes associated with a first electrical switch. The first electrical switch may be selected from the available switches based on two criteria: (1) it has a number of available nodes that is greater than the number of nodes required to execute the task, ensuring that the task can be fully accommodated, and (2) it has the minimum number of available nodes among the available switches that meet the first criterion. Such a selection may minimize the underutilization of nodes on other switches and maximizes the use of resources on the selected switch.

In specific embodiments, the system may first determine whether the task allocation spans a singular electrical switch. If the task allocation does not span the singular electrical switch, then the system may determine whether the task allocation spans multiple electrical switches. In an instance in which the total number of available nodes is less than the number of nodes required to execute the task, the system may transmit an alert to a user indicating that the task allocation request was unsuccessful. This alert provides the user with immediate feedback regarding the system's inability to meet the computational resource requirements at the time of the request. The alert may include details such as the number of nodes requested, the number of available nodes, and the reason for the failure, such as insufficient resources or network constraints. This allows the user to make informed decisions about modifying the task parameters, adjusting the requested resources, or resubmitting the request at a later time when more resources are available.

In some embodiments, the system may further provide an option for queuing the task allocation request until additional nodes become available. Upon queuing, the system may place the request in a wait state, monitoring the availability of resources in real-time. When the required number of nodes becomes available—either through the completion of other tasks, node recovery, or network optimization—the system may automatically process the queued request. Queuing ensures that the task will be allocated as soon as resources are freed, without requiring the user to manually resubmit the request. Additionally, the system may periodically notify the user of the task's status in the queue, including an estimated time for allocation based on current resource usage.

As shown in block 308, portions of the task are assigned to the plurality of available nodes such that links required to interconnect allocated electrical switches via corresponding optical switches is minimized. In example embodiments, the system may employ a strategy to minimize the number of electrical switches required to efficiently allocate the task across available computing nodes, ensuring optimal resource utilization and reducing inter-switch communication overhead. For example, in embodiments where the task is a DLRM task, the system may calculate the minimum number of electrical switches required to place the task, based on the number of nodes needed for the task and the number of available nodes per electrical switch. Then, the system may generate two lists: List 1, which may include all the electrical switches in the network environment sorted in descending order based on the number of available nodes on each electrical switch, and List 2, which may include only the electrical switches with enough free nodes (equal to or greater than the number required to complete the task). List 2 may be sorted in ascending order, prioritizing electrical switches that are closest to the necessary number of nodes to reduce network fragmentation and ensure more efficient resource utilization. If only one electrical switch is required to meet the task's node requirements, and that switch exists in List 2, the system may allocate the necessary nodes from the first electrical switch in List 2. This approach optimizes resource allocation by concentrating the task on a single switch when possible, reducing inter-switch communication.

In instances where multiple electrical switches are required, the system will proceed as follows. While the number of nodes assigned remains less than the number of nodes needed for the task, the system may iterate through List 1, selecting the electrical switches with the highest number of available nodes, and assigning the nodes until the task is fully allocated. If, after exhausting the available electrical switches, the system has still not met the required number of nodes, the system may return an error, indicating that the allocation request was unsuccessful.

In another example, in embodiments where the task is an LLM task and employs 3 types of parallelism, TP, DP and PP, the system may calculate the minimum number of electrical switches needed to accommodate the task, based on the total number of nodes required for the task and the number of available nodes per electrical switch. Accordingly, the system may generate two lists: List 2, which may include electrical switches with enough free nodes to satisfy the task's node requirements (equal to or greater than the nodes needed), sorted in ascending order. This ordering prioritizes electrical switches that are closest to the necessary uplink ports to reduce network fragmentation. Next, the system may create List 3, which includes electrical switches that meet both conditions: they have free nodes greater than or equal to the number required for PP and have at least twice the number of available uplinks as the PP dimension (i.e., free uplinks >=2*PP). List 3 is sorted based on a strategy that may alternate between ascending and descending order, depending on the task's requirements and network configuration. If the minimum number of electrical switches required equals one, and there are eligible switches in List 2, the system may allocate the necessary nodes from the first switch in List 2, aiming to occupy the fewest switches possible.

In cases where multiple electrical switches are required, the system may select the first electrical switch from List 3 and assigns nodes to it in multiples of the pipeline parallelism (PP) dimension, provided the total number of nodes assigned remains less than the number of nodes needed. Specifically, the number of nodes allocated may be determined by dividing the available nodes on the switch by PP (k=free nodes/PP) and then allocating k*PP nodes to the task. This ensures that the nodes are distributed in a way that aligns with the parallelism requirements of the LLM task since it contains the communication related with the PP dimension within the limits of the respective electrical switches, eliminating the need for inter-switch links for this communication. By exposing only the DP-related communication on the inter-switch domain and creating rings for the collective operations, the task requires 2 links for every DP group and as a result 2*PP links from every electrical switch that is allocated for the task. If, after processing all available switches in List 3, the system is unable to assign the necessary number of nodes, the system may return an error, indicating that the allocation request could not be fulfilled.

As shown in block 310, the task is executed using the plurality of available nodes. During execution, each node processes its assigned portion of the task in coordination with other nodes based on the task's communication and parallelism requirements. For tasks involving parallel processing methods, such as data, tensor, pipeline, or expert parallelism, the system ensures that nodes communicate in accordance with the designated communication patterns to maintain performance efficiency and reduce latency. In embodiments utilizing multiple parallelism strategies, the system may dynamically manage inter-node data exchanges to align with the specific parallelism configurations, including data reduction operations, scatter-gather techniques, or point-to-point communications, as described herein. In example embodiments, throughout execution, the system may monitor resource utilization and adjust data transmission rates or node processing loads to address variations in computational demands, such as those resulting from changes in input data size or model complexity.

### Example Segment of the Network Environment Illustrating Optimal Resource Allocation

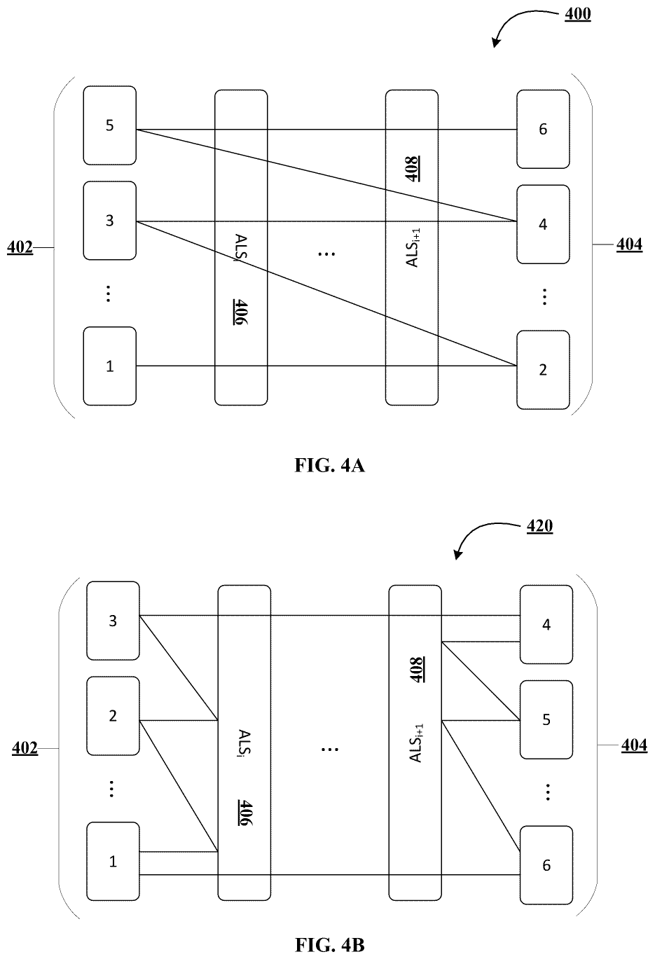

FIGS. 4A and 4B illustrate an example segment of the network environment illustrating optimal resource allocation 400, 420, in accordance with an embodiment of the disclosure. FIGS. 5A and 5B illustrate two node blocks 402, 404 operatively coupled to corresponding ALSs 406, 408. A node block may refer to a cluster of nodes that are operatively interconnected under a singular switch (e.g., electrical switch ALSᵢ).

As shown in FIG. 5A, node block 402, comprising nodes 1, 3, and 5, is operatively coupled to ALSᵢ 406 and node block 404, comprising nodes 2, 4, and 6, is operatively coupled to ALSᵢ₊₁ 406. In FIG. 5A, communication between nodes in different blocks (e.g., nodes 1 and 2, 3 and 4, and 5 and 6) occurs across the electrical switches 406 and 408. This inter-switch communication requires the use of uplinks through optical links (not shown). As the nodes are distributed across different switches, multiple communication flows need to traverse these uplinks, which may increase the use of optical resources and introduce additional latency into the network. This scenario illustrates how suboptimal placement of neighboring nodes in different blocks can result in increased dependence on optical inter-switch communication, requiring more uplinks to maintain performance.

In contrast, FIG. 5B shows a more optimal resource allocation, where neighboring nodes in the pipeline are placed within the same electrical switch block. For instance, nodes 1 and 2 are both located in node block 402, while nodes 4 and 5 are located in node block 404. This configuration reduces the need for inter-switch communication, as most data transfers occur within the same electrical switch. As a result, fewer communication flows require uplinks, reducing the load on optical switches. Such an optimized node placement minimizes inter-switch communication, leading to improved task execution and reduced latency in the network environment and can be achieved by defining accordingly the rank order between the allocated nodes.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for resource allocation in a network environment comprising electrical switches and optical switches, the method comprising:
receiving a task allocation request, wherein the task allocation request comprises a task and a number of nodes required to execute the task;
determining available electrical switches required to allocate the task based on a number of nodes required to execute the task and a number of nodes associated with each available electrical switch, and/or a number of available uplinks in an uplink bundle associated with each electrical switch;
allocating the task to a plurality of available nodes associated with the available electrical switches;
assigning portions of the task to the plurality of available nodes such that links required to interconnect allocated electrical switches via corresponding optical switches is minimized; and
executing the task using the plurality of available nodes.

2. The method of claim 1, wherein allocating the task further comprises:
in an instance in which the task allocation spans multiple electrical switches, allocating portions of the task to available nodes associated with corresponding available electrical switches in a descending order of a number of available nodes associated with each corresponding available electrical switch until the task is successfully allocated.

3. The method of claim 1, further comprising:
in an instance in which the task allocation spans a singular electrical switch, allocating the portions of the task to available nodes associated with a first electrical switch,
wherein the first electrical switch is selected from the available electrical switches having a number of available nodes that are greater than the number of nodes required to execute the task, and
wherein the first electrical switch has a minimum number of available nodes among the available electrical switches.

4. The method of claim 3, further comprising:
in an instance in which the task allocation does not span the singular electrical switch, determining whether the task allocation spans multiple electrical switches.

5. The method of claim 1, further comprising:
in an instance in which a total number of available nodes is less than the number of nodes required to execute the task, transmitting an alert to a user indicating that the task allocation request was unsuccessful.

6. The method of claim 5, further comprising:
queuing the task allocation request until additional nodes are available.

7. The method of claim 1, wherein the task is a Large Language Model (LLM) task, wherein the LLM task employs multi-dimensional parallelism comprising at least one of data parallelism (DP), tensor parallelism (TP), pipeline parallelism (PP), or expert parallelism (EP).

8. The method of claim 7, wherein the plurality available nodes across the available electrical switches are operatively interconnected in a reduction communication pattern for the DP dimension, and wherein the portions of the task are assigned to the plurality of available nodes such that inter-switch communication is minimized.

9. The method of claim 7, wherein the plurality of available nodes across the available electrical switches are operatively interconnected in a point-to-point communication pattern for the PP dimension, and wherein the portions of the task are assigned to the plurality of available nodes such that inter-switch communication is minimized.

10. The method of claim 7, wherein the plurality of available nodes across the available electrical switches are operatively interconnected in an all-to-all communication pattern for the EP dimension, and wherein the portions of the task are assigned to the plurality of available nodes such that inter-switch communication is minimized.

11. The method of claim 1, wherein the task is a Deep Learning Recommendation Machine (DLRM) task, wherein the plurality of available nodes are operatively interconnected in an all-to-all, a reduction operation, or a scatter-gather communication pattern.

12. The method of claim 1, further comprising:
upon successful allocation of the task, determining the links required to interconnect the allocated electrical switches.

13. A system for resource allocation in a network environment, the system comprising:
a plurality of electrical switches;
a plurality of optical switches operatively coupled to the plurality of electrical switches;
resource allocation circuitry operatively coupled to the plurality of electrical switches and the plurality of optical switches, and configured to:
receive a task allocation request, wherein the task allocation request comprises a task and a number of nodes required to execute the task;
determine available electrical switches required to allocate the task based on a number of nodes required to execute the task and a number of nodes associated with each available electrical switch, and/or a number of available uplinks in an uplink bundle associated with each electrical switch;
allocate the task to a plurality of available nodes associated with the available electrical switches;
assign portions of the task to the plurality of available nodes such that links required to interconnect allocated electrical switches via corresponding optical switches is minimized; and
execute the task using the plurality of available nodes.

14. The system of claim 13, wherein the resource allocation circuitry is further configured to:
in an instance in which the task allocation spans multiple electrical switches, allocate portions of the task to available nodes associated with corresponding available electrical switches in a descending order of a number of available nodes associated with each corresponding available electrical switch until the task is successfully allocated.

15. The system of claim 13, wherein the resource allocation circuitry is further configured to:
in an instance in which the task allocation spans a singular electrical switch, allocate the portions of the task to available nodes associated with a first electrical switch,
wherein the first electrical switch is selected from the available electrical switches having a number of available nodes that are greater than the number of nodes required to execute the task, and
wherein the first electrical switch has a minimum number of available nodes among the available electrical switches.

16. The system of claim 15, wherein the resource allocation circuitry is further configured to:
in an instance in which the task allocation does not span the singular electrical switch, determine whether the task allocation spans multiple electrical switches.

17. The system of claim 13, wherein the resource allocation circuitry is further configured to:
in an instance in which a total number of available nodes is less than the number of nodes required to execute the task, transmit an alert to a user indicating that the task allocation request was unsuccessful.

18. The system of claim 17, wherein the resource allocation circuitry is further configured to:
queue the task allocation request until additional nodes are available.

19. The system of claim 16, wherein the task is a Large Language Model (LLM) task employing three-dimensional parallelism comprising data parallelism (DP), tensor parallelism (TP), and pipeline parallelism (PP),
the available nodes across the available electrical switches are operatively interconnected in a reduction communication pattern, and
the portions of the task are assigned to the plurality of available nodes such that inter-switch communication is minimized.

20. The system of claim 13, wherein the task is a Deep Learning Recommendation Machine (DLRM) task, wherein the plurality available nodes are operatively interconnected in an all-to-all, a reduction operation, or a scatter-gather communication pattern.

21. A computer program product for resource allocation in a network environment, the computer program product comprising a non-transitory computer-readable medium comprising code, when executed by a processor, causes the processor to:
receive a task allocation request, wherein the task allocation request comprises a task and a number of nodes required to execute the task;
determine available electrical switches required to allocate the task based on a number of nodes required to execute the task and a number of nodes associated with each available electrical switch, and/or a number of available uplinks in an uplink bundle associated with each electrical switch;
allocate the task to a plurality of available nodes associated with the available electrical switches;
assign portions of the task to the plurality of available nodes such that links required to interconnect allocated electrical switches via corresponding optical switches is minimized; and
execute the task using the plurality of available nodes.

22. The computer program product of claim 21, wherein the code, when executed by the processor, further causes the processor to:
in an instance in which the task allocation spans multiple electrical switches, allocate portions of the task to available nodes associated with corresponding available electrical switches in a descending order of a number of available nodes associated with each corresponding available electrical switch until the task is successfully allocated.
